(19) United States
(12) Patent Application Publication
(10) Pub. No.: US 2017/0367486 A1
(43) Pub. Date: Dec. 28, 2017

(54) Modular Furniture Assembly Corner Seating System

(71) Applicant: SAC ACQUISITION LLC, Stamford, CT (US)

(72) Inventors: Shawn D. Nelson, Darien, CT (US); David M. Underwood, Norwalk, CT (US); Brian Kuchler, Stamford, CT (US); Chelsea Kostek, Bridgeport, CT (US)

(21) Appl. No.: 15/276,524

(22) Filed: Sep. 26, 2016

Related U.S. Application Data
(60) Provisional application No. 62/354,426, filed on Jun. 24, 2016.

(51) Int. Cl. A47C 4/02; F16B 12/10; A47C 15/00

(52) U.S. Cl. CPC A47C 4/028; A47C 15/002; F16B 12/10

(57) ABSTRACT

A modular furniture assembly including a wedge shaped base for use with other modular furniture system rectangular bases and transverse members, all of which components adhere to an (x)=(y)+(z) relationship, wherein (x) is the length of the back of the wedge shaped base, the length of the transverse member, and the length of the rectangular base. (y) is both the length of the angled side(s) of the wedge shaped base, and the width of the rectangular base. (z) is the width (i.e., thickness) of the transverse member. The angled sides of the wedge shaped base can be at or about 45° relative to one another. The rectangular bases and wedge shaped bases are of the same height, and all can be coupled together in a wide variety of modular furniture configurations.

### CROSS-REFERENCE TO RELATED APPLICATIONS

The present application claims the benefit of U.S. Patent Application 62/354,426 filed Jun. 24, 2016, and entitled MODULAR FURNITURE ASSEMBLY CORNER SEATING SYSTEM, which is incorporated herein by reference in its entirety.

### SPECIFICATION

### 1. Field of the Invention

This invention is in the field of modular furniture.

### 2. Background

Modular furniture is useful in a variety of settings. Consumers eager to have options for arranging furniture in multiple ways can purchase modular furniture which will allow them to set up furniture assemblies in one of a plurality of different of manners.

In addition, many traditional couches and other furniture items cannot be moved into tight areas of a home or apartment complex, including, for example, basements, narrow hallways, or upstairs rooms. Thus, it is often desirable to produce furniture that can be conveniently assembled, disassembled and then reassembled in one of a variety of configurations, thus, providing versatility, diversity, and convenience for transport and set up.

Furniture assemblies have been developed in the past that provide the user with the opportunity to set up furniture in various different manners and to conveniently transport one portion of the furniture assembly at a time, rather than requiring the purchaser to negotiate a tight hallway with an entire sofa, for example.

However, while numerous configurations are possible while using the modular members available, there is still a continuing need for additional differently configured modules that would further increase the variety of configurations possible.

### BRIEF SUMMARY

The present disclosure relates to a modular furniture assembly including a wedge shaped base. The wedge shaped base includes geometric relationships so as to be compatible with the bases and transverse members of the modular furniture assemblies described in U.S. Pat. Nos. 7,213,885; 7,419,220; 7,547,073; 7,963,612; 8,783,778; 9,277,826; and U.S. application Ser. Nos. 14/993,533; and 15/058,656, each of which is incorporated herein by reference, and which disclose modular furniture assemblies in which a base and a transverse member, and/or multiple bases and transverse members, can be used in a variety of different configurations in light of their novel dimensions and relationships, such as (x)=(y)+(z), wherein (x) is the length of the base and is substantially equal to the length of the transverse member, (y) is the width of the base, and (z) is the width of the transverse member.

In one aspect, the present invention is directed to a modular furniture assembly including a transverse member having a length (x′) and a width (z). The assembly further includes a wedge shaped base which enables convenient corners and angles in furniture assemblies, the wedge shaped base being configured such that the wedge shaped base has a length (x) at a back thereof and an angled side length (y). The wedge shaped base and transverse member have a defined special relationship in which the length (x) of the back of the wedge shaped base is substantially equal to the length (x′) of the transverse member, and the length (x) of the back of the wedge shaped base is substantially equal to the sum of the length of the angled side (y) of the wedge shaped base and the width (z) of the transverse member, such that different furniture configurations can be formed. The wedge shaped base enables a variety of corners and angles in furniture configurations which further enhance the usefulness of the modular furniture assemblies.

Another aspect of the present invention is directed to a modular furniture assembly including: (1) first and second transverse members, each having a length (x′) and a width (z); (2) a wedge shaped base configured such that the wedge shaped base has a length (x) at a back thereof and an angled side length (y); and (3) a rectangular base configured such that the rectangular base has a length (x) and a width (y). The wedge shaped base, the rectangular base, and the transverse members have a defined spatial relationship in which: (a) the length (x) of the back of the wedge shaped base and the length (x) of the rectangular base are each substantially equal to the length (x′) of each of the transverse members; (b) the length (x) of the back of the wedge shaped base and the length (x) of the rectangular base are each substantially equal to the sum of the length of the angled side (y) of the wedge shaped base and the width (z) of each of the transverse members such that (x)=(y)+(z), and (x′)=(y)+(z) such that different furniture configurations can be formed.

As a result of this geometric or spatial relationship, the length (x) of the back of the wedge shaped base is equal to the length (x) of the rectangular base, and (x) is also substantially equal to the length (x′) of the transverse member, and (x) is also substantially equal to the sum of (y) and (z), wherein (y) is the length of the angled side of the wedge shaped base and (y) is also the width of the rectangular base. The first transverse member is selectively coupleable to the back of the wedge shaped base, the rectangular base is selectively coupleable to the angled side of the wedge shaped base, and the second transverse member is selectively coupleable to the rectangular base (e.g., to the back or side thereof)

Another aspect of the present invention is directed to a modular furniture assembly comprising a plurality of transverse members, each having a length (x′) and a width (z), first and second wedge shaped bases, and a rectangular base. Each wedge shaped base is configured such that the wedge shaped bases each have a length (x) at a back thereof and an angled side length (y). The rectangular base has a length (x) and a width (y). The wedge shaped bases, the rectangular base, and the transverse members have a defined spatial relationship in which: (a) the length (x) of the back of each wedge shaped base and the length (x) of the rectangular base are each substantially equal to the length (x′) of each of the transverse members; (b) the length (x) of the back of each wedge shaped base and the length (x) of the rectangular base are each substantially equal to the sum of (y) and (z), wherein (y) is both the length of the angled side of each wedge shaped base and the width of the rectangular base, and (z) is the width of each of the transverse members, such that (x)=(y)+(z), and (x′)=(y)+(z). This spatial relationship allows different furniture configurations to be formed. The first wedge shaped base is selectively coupleable to the second wedge shaped base along corresponding angled sides of the first and second wedge shaped bases so as to form a 90° bend across the first and second wedge shaped bases, and the rectangular base is selectively coupleable to a remaining angled side of the wedge shaped base, while the plurality of transverse members are selectively coupleable to the wedge shaped bases or the rectangular base (e.g., as backrests or armrests therefor).

Another aspect of the present invention is directed to a modular furniture assembly forming a convenient angle, the assembly comprising at least four transverse members, each having a length (x′) and a width (z), first and second wedge shaped bases, and first and second rectangular bases. Each wedge shaped base is configured such that the wedge shaped bases each have a length (x) at a back thereof and an angled side length (y). Each rectangular base has a length (x) and a width (y). The wedge shaped bases, the rectangular bases, and the transverse members have a defined spatial relationship in which: (a) the length (x) of the back of each wedge shaped base and the length (x) of each rectangular base are each substantially equal to the length (x′) of each of the transverse members; (b) the length (x) of the back of each wedge shaped base and the length (x) of each rectangular base are each substantially equal to the sum of (y) and (z), wherein (y) is both the length of the angled side of each wedge shaped base and the width of each rectangular base, and (z) is the width of each of the transverse members, such that (x)=(y)+(z), and (x′)=(y)+(z). This spatial relationship allows different furniture configurations to be formed, e.g., one in which the two wedge shaped bases, the two rectangular bases, and the four transverse members collectively form a modular furniture assembly that aligns along first and second axes, wherein the second axis is transverse to the first axis (e.g., a corner couch modular furniture assembly).

### DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an exemplary modular furniture assembly including a rectangular base and a transverse member;

FIG. 2 is an exploded and cut-away view of the modular furniture assembly of FIG. 1, showing the coupling of the transverse member to the base member;

FIG. 3 shows a front perspective view of an exemplary modular furniture assembly that can be formed using the wedge shaped base(s) of the present invention;

FIG. 4 shows a side perspective view of the modular furniture assembly of FIG. 3;

FIG. 5 shows another side perspective view of the modular furniture assembly of FIG. 3, with the cushion removed to better show the wedge shaped base and the transverse member;

FIG. 6 is a top plan view of the modular furniture assembly of FIG. 5;

FIG. 7 is an exploded view of an exemplary frame assembly of a wedge shaped base, with inner and outer fabric covers removed from the frame assembly;

FIG. 8 is a perspective view of the frame assembly of FIG. 7 with the fabric covers removed;

FIG. 9 is a bottom perspective view of the frame assembly of FIG. 8 showing the underside of the frame assembly of FIG. 8;

FIG. 10 shows an exploded view of exemplary components that can be used in assembling the frame assembly of FIG. 8;

FIG. 11 is a cut-away bottom perspective view into the frame assembly of FIG. 8;

FIG. 12 is a top plan view of the frame assembly of FIG. 8, with feet and other hidden structures shown in phantom;

FIG. 13 is a front view of the frame assembly of FIG. 8;

FIG. 14 is a perspective view showing couplers that can be used to couple a wedge shaped base to another base (e.g., a rectangular shaped base), and to couple the bases to corresponding transverse members.

FIG. 15 is a perspective view of an exemplary mounting platform that can be used to couple the wedge shaped base to another base (e.g., rectangular or wedge shaped), and/or to a transverse member;

FIG. 16 is a perspective view of another exemplary mounting platform that can be used to connect a rectangular or wedge shaped base to another base (e.g., rectangular or wedge shaped), and/or a transverse member;

FIG. 17A shows a top plan view of an exemplary modular furniture assembly including one or more wedge shaped bases, one or more rectangular bases, and one or more transverse members;

FIG. 17B is a bottom plan view of the modular furniture assembly of FIG. 17A, showing use of the mounting platforms of FIGS. 15-16 to selectively couple the bases and transverse members together into the modular furniture assembly;

FIG. 17C is a bottom perspective view of the modular furniture assembly of FIG. 17A;

FIG. 18A is a front perspective view of the modular furniture assembly of FIG. 17A;

FIG. 18B is a perspective view similar to that of FIG. 18A, but showing the addition of cushions positioned against the transverse members;

FIGS. 19A-19E are top plan views of various additional possible modular furniture assemblies that can be formed from one or more wedge shaped bases, one or more rectangular bases, and one or more transverse members;

FIGS. 20A-20F reflect views of a wedge shaped base 12a of the present invention, wherein any broken lines are shown for environmental purposes only;

FIG. 20A is a perspective view of an embodiment of a wedge shaped base 12a of the present invention;

FIG. 20B is a top view of the wedge shaped base of FIG. 20A;

FIG. 20C is a rear view of the wedge shaped base of FIG. 20A;

FIG. 20D is a front view of the wedge shaped base of FIG. 20A;

FIG. 20E is a right side view of the wedge shaped base of FIG. 20A; and

FIG. 20F is a left view of the wedge shaped base of FIG. 20A.

### DETAILED DESCRIPTION

The invention relates to a modular furniture assembly that can be assembled, disassembled, rearranged, moved and cleaned in a quick and efficient manner with minimal effort. The invention further relates to modular furniture assemblies that have a spatial relationship such as those described U.S. Pat. Nos. 7,213,885; 7,419,220; 7,547,073; 7,963,612; 8,783,778; 9,277,826; U.S. application Ser. Nos. 14/993,533; and 15/058,656, each of which is incorporated herein by reference, which enable a user to form a number of different furniture assemblies. The above referenced patents and applications describe such systems assembled from one or more bases (e.g., rectangular bases) and one or more transverse members. The present invention increases the utility of such modular furniture assemblies by providing a wedge shaped base compatible therewith. In particular, the modular furniture assemblies include at least one transverse member having a length (x′) and a width (z), and a wedge shaped base with a length at the back (x) and an angled side length (y), wherein (x) is substantially equal to (x′), and wherein (x) is substantially equal to (y)+(z). This configuration provides convenient angling and rounding of corners as shown in the Figures.

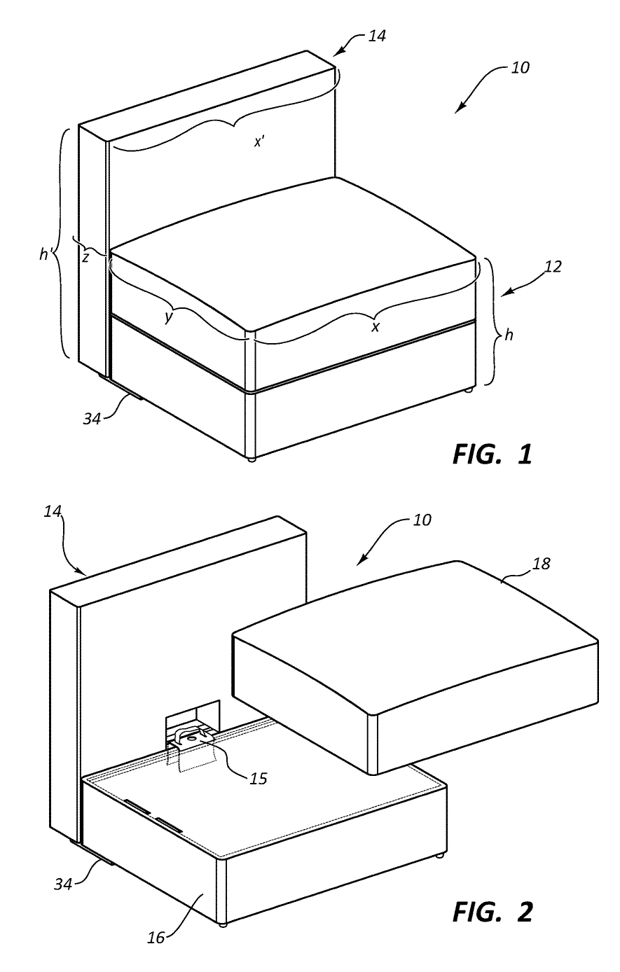

FIG. 1 illustrates an exemplary embodiment of a modular furniture assembly 10, such as those described in the above referenced patents and applications. In the illustrated embodiment, modular furniture assembly 10 comprises a rectangular base 12 and a transverse member 14 detachably coupled to rectangular base 12 by a coupler 15 (FIG. 2). Base 12 and transverse member 14 are adapted to be detachably coupled to each other in a variety of ways and configurations so as to form a variety of unique and custom furniture assemblies. Further, rectangular base 12 and transverse member 14 are sized and configured according to a defined spatial relationship.

The spatial relationship between rectangular base 12 and transverse member 14 enables the formation of a variety of different types, sizes and configurations of furniture assemblies. In this embodiment, rectangular base 12 has a length (x) and a width (y), wherein the length (x) of rectangular base 12 is greater than the width (y) of base 12, and transverse member 14 has a length (x) and a width (z), wherein the length (x′) of transverse member 14 is greater than the width (z) of transverse member 14. In the illustrated embodiment, rectangular base 12 and transverse member 14 are configured such that the length (x) of base 12 is substantially equal to the length (x) of transverse member 14 and the length (x) of base 12 is substantially equal to the sum of the width (y) of rectangular base 12 and the width (z) of transverse member 14. As such, (x) is substantially equal to (y)+(z).

Furthermore, the height (h′) of transverse member 14 is substantially greater than the height (h) of base 12, such that transverse member 14 can be conveniently employed as a backrest or armrest while base 12 is employed as a seat. As shown in FIG. 2, rectangular base 12 comprises a removable cushion 18. Cushion 18 is configured to be mounted on a frame assembly 16 of rectangular base 12 so as to provide a useful and comfortable sitting area for a user. Cushion 18 has the same length and width dimensions (x) and (y) as underlying frame assembly 16, so that both share the (x) and (y) length and width dimension characteristics. Cushion 18 can be easily mounted on or removed from frame assembly 16, providing easy access to coupler 15.

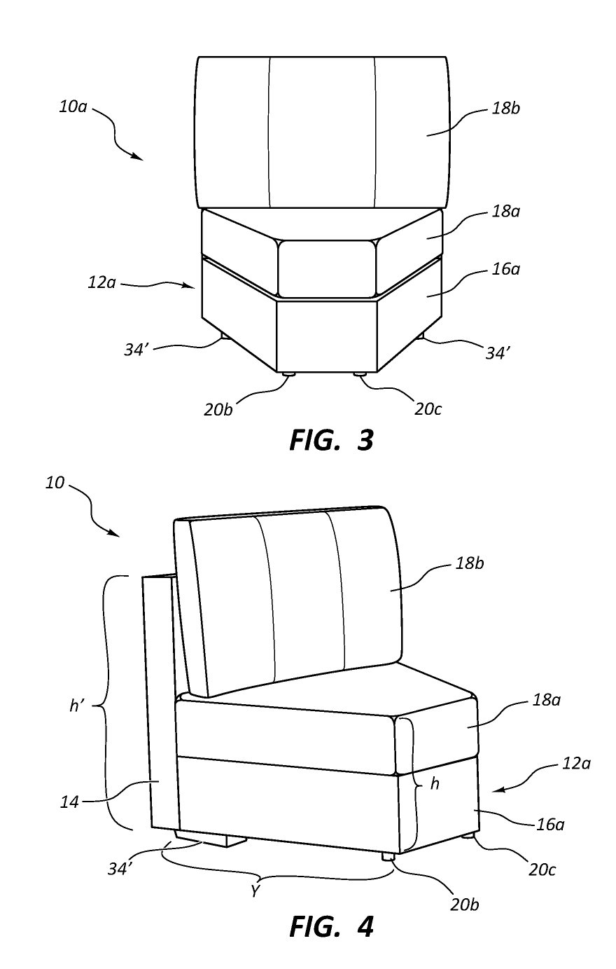

FIGS. 3-6 illustrate an exemplary modular furniture assembly 10a according to the present invention, and which includes a spatial relationship between the components thereof that is compatible with the spatial relationship of modular furniture assembly 10, described above. Assembly 10a is shown as including a wedge shaped base 12a, and a transverse member 14 (FIG. 4). The transverse member 14 of FIGS. 3-6 may be identical to transverse member 14 described above in conjunction within FIGS. 1-2. Couplers 15 such as those described above in conjunction with FIGS. 1 and 2 may likewise be used to selectively couple wedge shaped base 12a with transverse member 14, to couple wedge shaped base 12a to a rectangular base 12, to another wedge shaped base 12a, or any combination thereof.

As perhaps best seen in FIG. 6, wedge shaped base 12a and transverse member 14 are sized and configured according to a defined spatial relationship in which wedge shaped base 12a has a length (x) at a back thereof and an angled side length (y), wherein the length (x) of the back of wedge shaped base 12a is greater than the angled side length (y) of wedge shaped base 12a, and transverse member 14 has a length (x) and a width (z), as described above, wherein the length (x) is substantially equal to the length (x′) of transverse member 14 and the length (x) of the back of wedge shaped base 12a is substantially equal to the sum of the length (y) of the angled side of wedge shaped base 12a and the width (z) of transverse member 14. As such, (x) is substantially equal to (y)+(z). This relationship remains true for both the rectangular base 12 and transverse member 14, and the wedge shaped base 12a and transverse member 14, as will be apparent. In other words (x) is thus equal to both the length of the back of the wedge shaped base 12a, and equal to the length of rectangular base 12. Similarly, it will be apparent that (y) is thus equal to both the length of the angled side(s) of the wedge shaped base 12a, and equal to the width of the rectangular base 12. It will also be apparent that (x) is also equal or substantially equal to (x′), the length of transverse member 14, and (x) is equal to the sum of (y) and (z).

Because the wedge shaped base 12a, the rectangular base 12, and the transverse member all incorporate the (x)=(y)+(z) spatial relationship, the wedge shaped base 12a can be incorporated into a furniture assembly including rectangular shaped bases to be coupled thereto (e.g., at either or both angled sides, or even along the back), to form a corner, bend, curve or other shape within couch or other modular furniture assembly being assembled. The wedge shaped base thus provides an additional degree of freedom to construct furniture configurations not possible using only rectangular bases and transverse members.

FIGS. 3-6 illustrate these dimensions (x), (y), (z), and (x′) associated with wedge shaped base 12a and transverse member 14. In addition, similar to rectangular base 12, wedge shaped base 12a can be employed as a seat, and includes a removable cushion 18a placed thereon (e.g., wedge shaped like base 12a). Cushion 18a is configured to be mounted on a frame assembly 16a of wedge shaped base 12a so as to provide a useful and comfortable sitting area for a user. Cushion 18a can be easily mounted on or removed from frame assembly 16a, providing easy access to a coupler 15, e.g., used for selectively coupling wedge shaped base 12a to one or more of transverse member 14, a rectangular base 12, or another wedge shaped base 12a. Another cushion 18b can be provided e.g., leaned against the upper portion of transverse member 14, which may not be used as a seat, but as a cushion against the backrest or armrest provided by the upper portion of transverse member 14.

Frame assembly 16a also comprises a plurality of feet (e.g., 20a-20d) mounted on frame assembly 16a, which feet function in conjunction with one or more foot couplers (e.g., foot couplers 34′ and/or 34) to aid in selectively coupling the wedge shaped base 12a to another base (whether wedge shaped or rectangular), to a transverse member 14, or both.

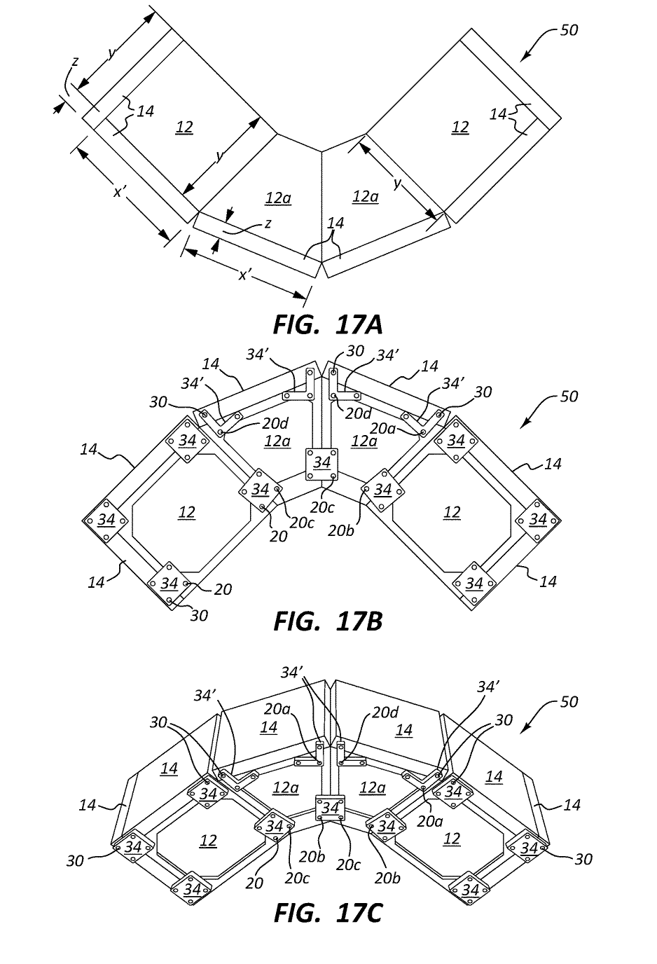

As perhaps best seen in FIG. 6, the angle between the two angled sides (y) of the wedge shaped base 12a is at or about 45° relative to one another, so as to provide a 45° bend (or approximately 450 bend) in the seating surface into which the wedge shaped base 12a is incorporated. In other embodiments, other angles may alternatively be possible (e.g., 30°, 60°, or any angle therebetween). Angles other than 30°, 45° or 60°, such as greater than 0° and less than 90°, or from 90° to 180° could alternatively be provided. Additive versions of such angles could also be provided. For example, a 135° bend in a furniture assembly (e.g., a couch) can be achieved with three 45° wedges, or a single wedge shaped base could be provided with angled sides at 1350 relative to one another, effectively consolidating three 45° wedges into one component. It will be apparent from this description that other corner seat configurations with an additive angle could be provided (e.g., 90°, etc.). FIGS. 17A-18B show an example of how two 450 wedge shaped bases can be coupled together to provide a 90° bend in the resulting couch or other furniture assembly. Eight 45° wedge shaped bases could be used to form a circular modular furniture assembly. Numerous other varieties are also possible.

As shown in FIG. 6, the angled sides each have a length (y), and both sides are angled at 45°, for example, forming (about) a 45° angle therebetween. With equal length sides (y), the angle between either angled side (y) and the back (x) is 67.5°. The illustrated 45° angling is particularly beneficial, as one wedge shaped base can be used to provide a 45° bend in the furniture configuration, two such bases 12a can provide a 90° bend, three such bases 12a can provide a 135° bend, and so forth. Also apparent from FIG. 6, the wedge shape of base 12a (and frame assembly 16a and cushion 18a) is shown as generally triangular, or more particularly, generally a truncated triangle (e.g., a triangle in which the 45° angle apex has been removed). Such a truncated triangle of FIG. 6 may also be described as generally trapezoidal in shape.

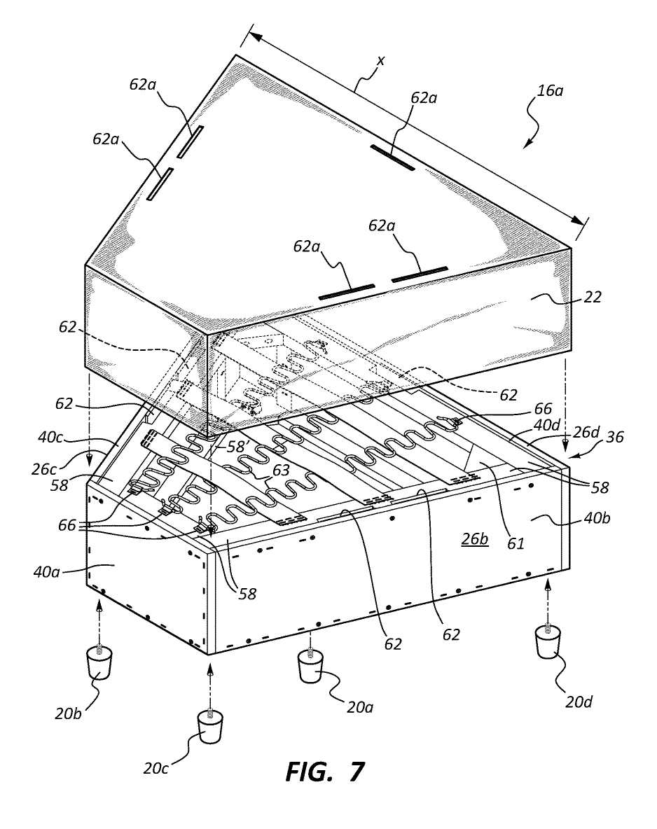

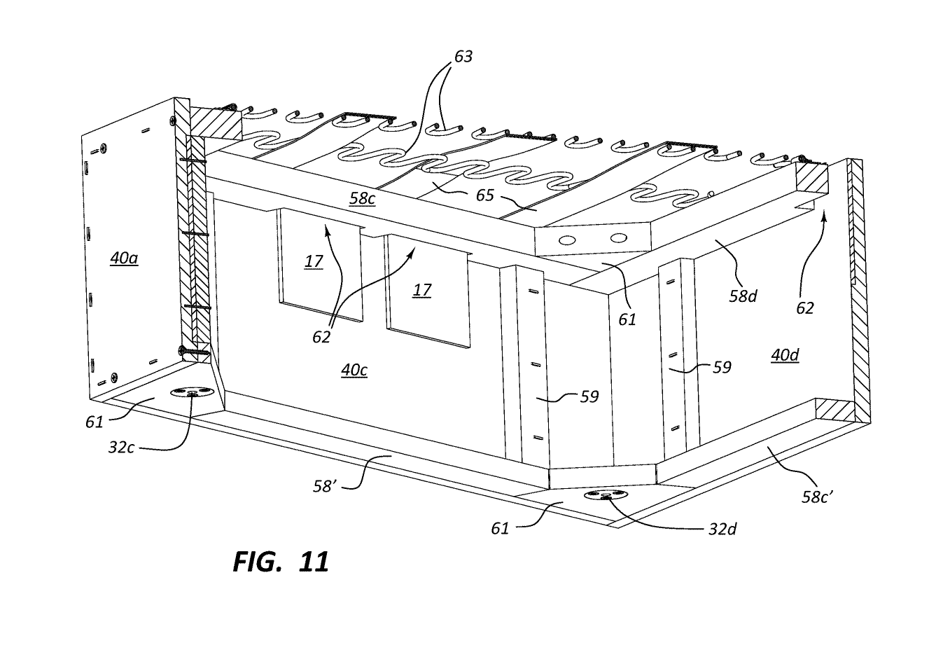

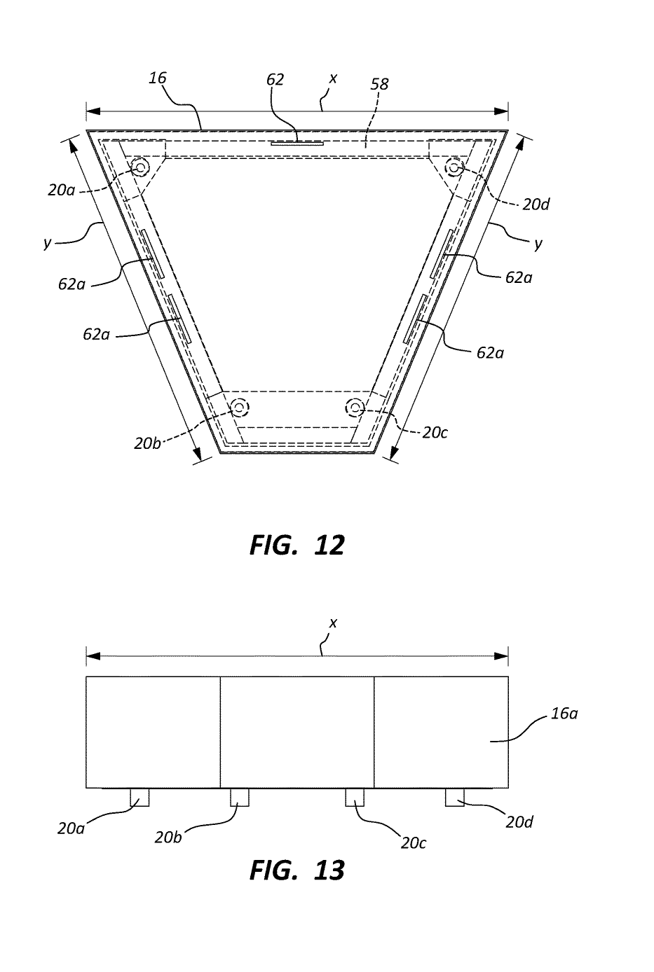

FIGS. 7-13 illustrate an exemplary embodiment of a frame assembly 16a of wedge shaped base member 12a, illustrating an example of how interior components thereof may be configured. It will be apparent that the illustrated and described configurations are merely exemplary, such that numerous other configurations are of course possible, in keeping with the above described geometric or spatial relationships. In the illustrated embodiment, frame assembly 16a is shown as including at least one removable cover 22. Wedge shaped base 10a is thus comprised of a frame 36 (or frame assembly 16a) and a removable cover 22. Removable cover 22 is configured to provide additional protection for frame 36 of frame assembly 16a, e.g., in the event that a soda, beverage, or other item is spilled on frame assembly 16a. For example, cover 22 prevents damage to the structure of frame 36, isolating the spill to cover 22, e.g., which may largely absorb the spill. Cover 22 is easily removed for laundering, and replacement. The removable characteristic of cover 22 also allows a user to change the color, pattern, or other aesthetic characteristics of the visible exterior of the frame assembly 16a, as desired. Cover 22 also covers frame members 40a-40d of frame 36 for aesthetics. Cover 22 may include both an inner cover and an outer cover.

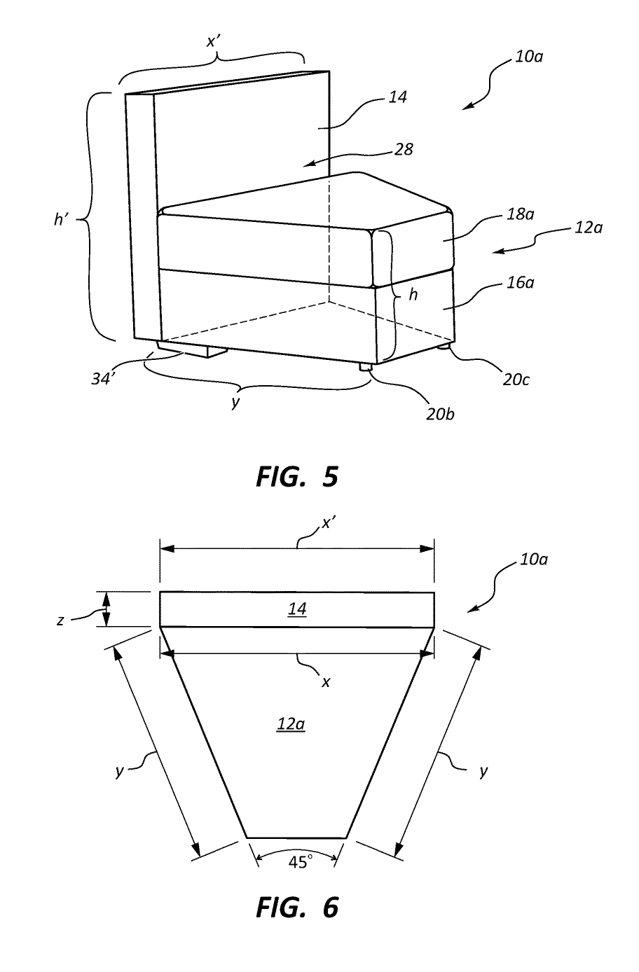

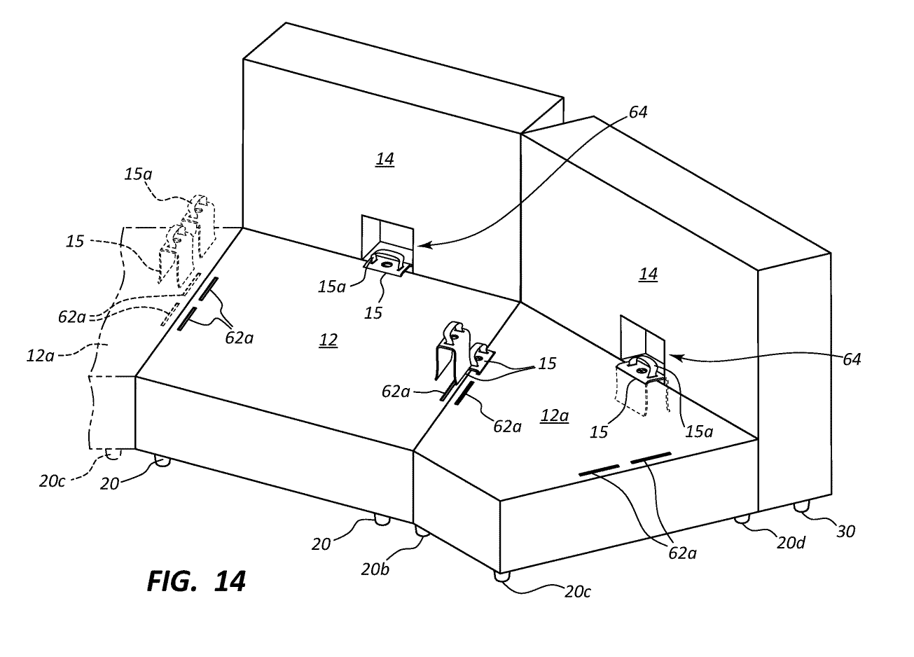

Cover 22 is detachably coupled to frame assembly 16a through a removable securing mechanism, such as a hook and pile mechanism, e.g. VELCRO, a zipper, or other suitable mechanism. Frame assembly 16a includes a plurality of abutting surfaces 26b-26d (the angled sides and back), associated with frame members 40b-40d. The front surface associated with frame member 40a is not typically abutted against another base or a transverse member, although such could be possible, if desired. Frame members 40a-40d may be made from wood, metal, composite, plastic, or any other structural material or combination of suitable materials. In the illustrated embodiment, abutting surfaces 26b-26d are respective substantially flat vertical surfaces configured to be positioned adjacent and abut the substantially flat abutting vertical surface 28 (FIG. 5) of transverse member 14, or abutting surfaces of other bases 12a, or 12. Coupler 15 can be used to couple wedge shaped base 12a to a transverse member 14, another wedge shaped base 12a, or a rectangular shaped base 12 by bringing the corresponding abutting surfaces together and inserting the coupler 15 into the provided apertures 62a (see FIG. 14).

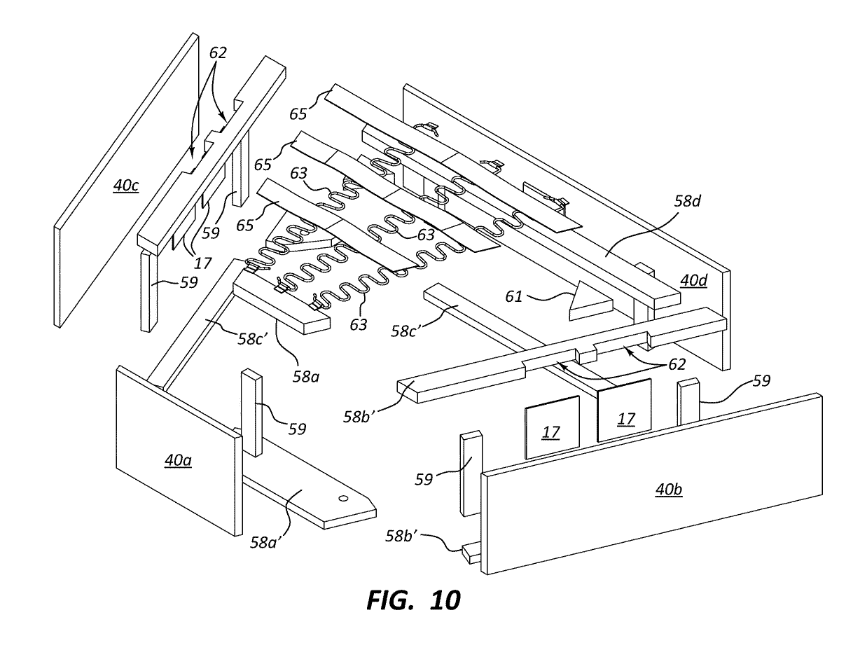

Returning to FIGS. 7-13, frame assembly 16a further comprises a support member 58 that is mounted between frame members 40a-40d. Support member 58 extends around at least a portion of an interior perimeter of frame 36 defined by frame members 40a-40d. In another embodiment, support member 58 may extend over the entire width, or substantially the entire width of frame 36, similar to the support member 58 described in U.S. Pat. No. 9,277,826, incorporated herein by reference, for example. For example, in one embodiment, support member 58 is mounted on a plurality of upstanding posts 59 positioned within the cavity defined by frame members 40a-40d. As shown, support member 58 comprises a plurality of structural members (e.g., elongate members 58a-58d), extending around the interior perimeter defined by frame members 40a-40d. As shown, support member 58 is disposed along a top of frame assembly 16a. An analogous support member 58′ formed from a plurality of structural members 58a′-58d′ is positioned along the bottom of frame assembly 16a, as perhaps best seen in FIGS. 9-10. One or more triangular corner supports 61 can be provided as part of either support member 58 or support member 58′, as desired. Support members 58 and/or 58′ may comprise any suitable structural material, such as wood metal, plastic, or the like.

As seen in FIGS. 7-13, structural members 58b, 58c, and 58d (those members along the angled sides and the back of frame assembly 16a) each include one or more grooves 62 formed therein. Grooves 62 are positioned along the perimeter of support member 58 and are sized so as to allow a portion of coupler 15 to be received therein. Grooves 62 are positioned in support member 58 so as to provide a variety of coupling locations on wedge shaped base 12a for the coupling of transverse member 14 to wedge shaped base 12a and/or coupling of wedge shaped base 12a to another base (either rectangular or wedge shaped).

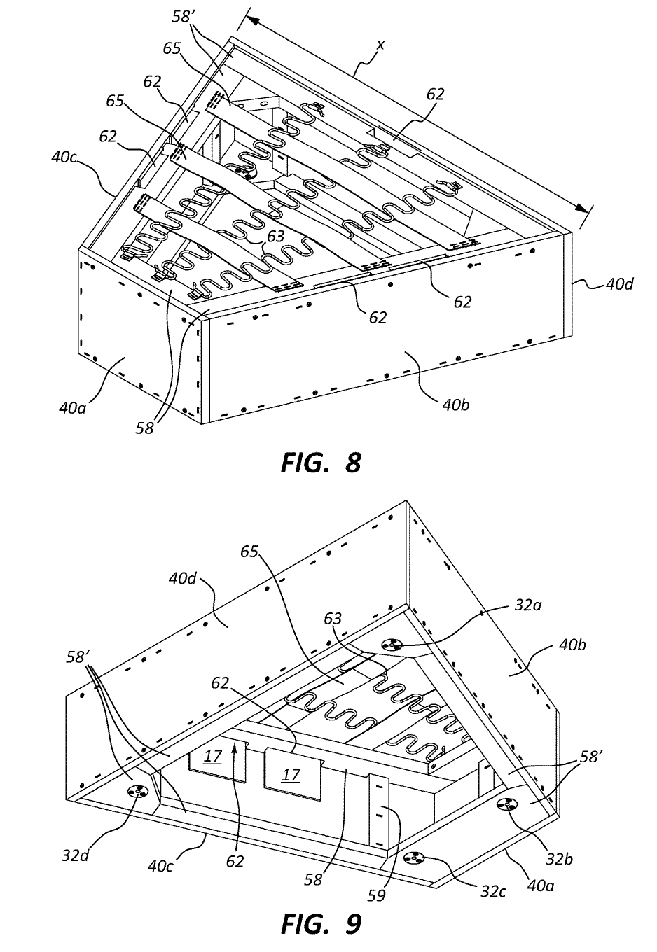

Grooves 62 each form a portion of an aperture in frame assembly 16a, as perhaps best seen in FIGS. 7-8. As seen in FIG. 7, cover 22 includes apertures 62a aligned with each of grooves 62, so as to easily allow a portion of couplers 15 to be inserted through apertures and grooves 62a and 62, respectively, coupling wedge shaped base to a transverse member 14, or to another base. In the illustrated embodiment, two grooves 62 are positioned adjacent respective abutting surfaces 26b and 26c, corresponding to length (y) along the angled sides of the wedge shaped base 12a, while one groove 62 is positioned adjacent abutting surface 26d, along the back of wedge shaped base 12a. In the illustrated embodiment, no groove is formed in the front structural member 58a, corresponding to the front of the wedge shaped base 12a, as typically no transverse member or other base is coupled thereto.

The two grooves 62 positioned adjacent respective abutting surfaces 26b and 26c enable the positioning of transverse member 14 (or a base) in two different locations adjacent each of abutting surfaces 26b and 26c, which enables the formation of different furniture configurations. Transverse member 14 can be positioned and coupled to wedge shaped base 12a by coupler 15 in at least five different positions in relation to wedge shaped base 12a, as there are five different grooves 62. Coupling can be accomplished, for example, by aligning an aperture of transverse member 14 with any of grooves 62 and placing a portion of coupler 15 in each of the aperture of the transverse member and the desired groove 62 of frame assembly 16a, as seen in FIG. 14. Similarly, coupling another base 12a or 12 is similarly accomplished by placing a portion of coupler 15 in each of the aperture of the base (12a or 12) and the groove of frame assembly 16a, as shown in FIG. 14. Examples of the apertures of the transverse member 14 are described in additional detail in U.S. Pat. No. 9,277,826, incorporated herein by reference (e.g., see FIGS. 3, and 5A-5C thereof).

As described in U.S. Pat. No. 9,277,826, coupler 15 can comprise an elongate, U-shaped member configured to be positionable within the aperture of transverse member 14 and one of grooves 62 of frame assembly 16a, or when two bases are to be coupled together, within one of the grooves 62 of a wedge shaped base 12a and one of the grooves 62 of a second base (e.g., another wedge shaped base 12a or a rectangular base 12). Coupler 15 is further configured to engage the inner surfaces of frame 36 of frame assembly 16a (e.g., engaging against MDF members 17 associated with frame members 40b-40d), sandwiching a portion of transverse member 14 and a portion of frame assembly 16a together between portions of coupler 15. MDF members 17 serves to reinforce frame assembly 16a in the region when coupling occurs, acting as a sort of grind plate which coupler 15 slides over during coupling. When coupling two bases together, the coupler similarly sandwiches portions of both frames between the legs of the coupler 15, as will be apparent from FIG. 14.

Coupler 15 is configured to substantially prevent movement of the upper portion of whatever two components are coupled, e.g., transverse member 14 in relation to wedge shaped base 12a, or rectangular base 12, or to prevent movement of the upper portions of two coupled bases (any combination of 12 and 12a), as the case may be. In this manner, coupler 15 substantially prevents movement of a first component (transverse member 14, base 12, or wedge shaped base 12a) in at least a first direction with respect to any base coupled therewith (e.g., a wedge shaped base 12a or a rectangular shaped base 12). Such prevention of movement is provided whether the coupled structures are a transverse member and a base (whether rectangular or wedge shaped), and where two bases (whether of the same shapes, or different shapes) are coupled together using coupler 15. Additional details of coupler 15 are disclosed in the above referenced patents and applications, incorporated herein by reference, as well as U.S. patent application Ser. No. 15/270,339, filed Sep. 20, 2016, which is also incorporated herein by reference in its entirety.

As shown in FIG. 14, coupler 15 includes a loop handle 15a secured to a top of coupler 15, facilitating easier removal of couplers 15 when a user desires to reconfigure the modular components of the modular furniture assembly.

Returning to the description of frame assembly 16a, FIGS. 7-11 show how one or more serpentine springs or zig-zag springs 63 (used interchangeably herein) can be provided, e.g., extending between structural members 58a and 58d. A plurality of straps 65 can be provided, e.g., extending between structural members 58b and 58c. As shown in FIG. 8, straps 65 are weaved alternatingly above and below serpentine springs 63, as they encounter each one. Straps 65 (e.g., formed of nylon or other suitable material) are shown as being stapled to structural members 58b and 58c. Springs 63 are secured to structural members 58a and 58d through any suitable mechanism, e.g., the illustrated hooks 66, or the like. While springs 63 are shown extending from the front structural member 58a to the back structural member 58d, and straps 65 are shown extending between the two angled side structural members 58b and 58c, it will be appreciated that the location of the springs 63 and straps 65 could be switched, and/or numerous other changes could also be made.

While exemplary internal components of frame assembly 16a have been shown and described in some detail, it will be appreciated that the illustrated configuration is merely exemplary, and numerous other configurations could alternatively be provided. Any of the individual features described herein in conjunction with the frame assembly 16a may be employed in any embodiment individually, with or without any of the other features described in conjunction with frame assembly 16a.

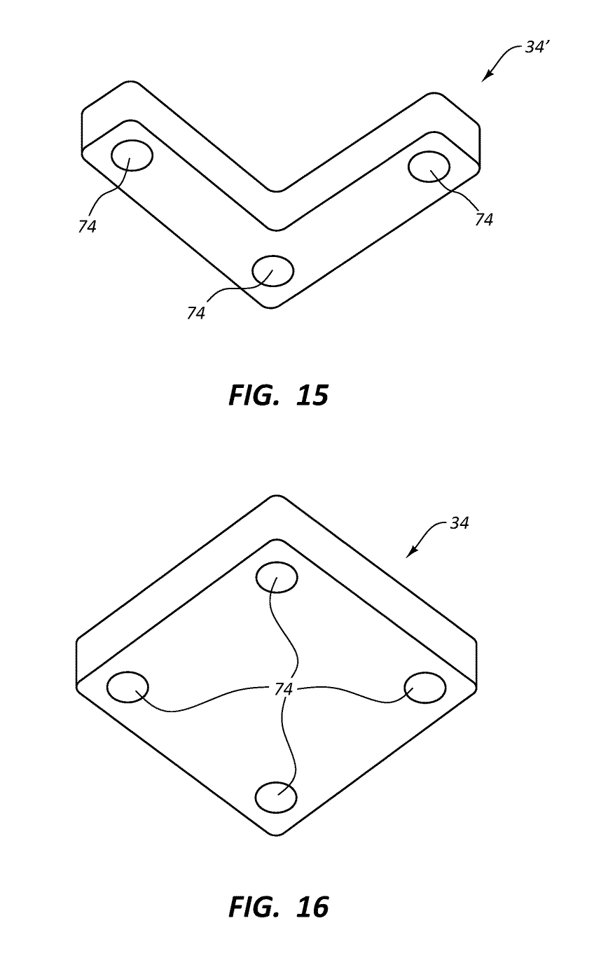

FIG. 14 illustrates how couplers 15 are used to couple wedge shaped base 12a to an adjacent rectangular base 12, and how both are coupled to transverse members 14 at the backsides of the bases 12a, 12, also using couplers 15. The aperture 64 seen in transverse member 14 is used as one leg of U-shaped coupler 15 is pressed into aperture 62a (and associated groove 62) of base 12a, while the other leg of coupler 15 is received into a slot below aperture 64, so that coupler 15 sandwiches a portion of the frame of base 12a and a portion of the frame of transverse member 14 between the legs of coupler 15. Once cushions 18 and 18a (associated with bases 12 and 12a) are positioned over frame assemblies 16 and 16a, apertures 64 of transverse member 14 are hidden. As described in further detail below, the legs of the bases and transverse members are also coupled together at a lower portion thereof, e.g., using foot couplers 34, or 34′, of FIGS. 15-16.

In addition to coupling along an upper portion of wedge shaped base 12a, provided by coupler 15, a mechanism is also provided for coupling a lower portion of base 12a (or 12) with another base (12 or 12a) or for coupling to a transverse member 14. Referring to FIGS. 15-16, two exemplary foot couplers 34 and 34′ are shown. Foot coupler 34 shown in FIG. 16 may be substantially the same as that described in U.S. Pat. No. 9,277,826, for example. Both couplers include a plurality of apertures 74. Foot coupler 34′ of FIG. 15 is shown as being generally L-shaped, with 3 apertures, while foot coupler 34 is shown with 4 apertures. As shown in FIGS. 17B-17C, the L-shaped foot couplers 34′ are particularly configured for use at the back of wedge shaped base members 12a (adjacent length (x)), for coupling such base members 12a to transverse members 14. Apertures 74 are sized and configured to receive a foot of any base 12a, 12 or transverse member 14 therein. Apertures 74 of foot coupler 34′ are sufficiently spaced apart, such that when a foot 30 from transverse member 14 is positioned in aperture an 74 and a back foot 20a or 20d from wedge shaped base 12a is positioned in another aperture 74 of the same coupler 34′, transverse member 14 and wedge shaped base 12a are adjacent and in contact one with another, with transverse member 14 positioned along the back length (x) of wedge shaped base 12a. Coupler 34′ thus couples the two structures together, as transverse member 14 forms a backrest for wedge shaped base 12a.

The foot couplers 34, 34′ are configured to substantially prevent movement of the bottom portion of transverse member 14 in relation to a coupled base 12a or 12. When coupling bases (e.g., 12a or 12) to one another, such prevention of relative movement of the coupled bases is also obtained. In this manner, the foot couplers substantially prevent movement of a coupled transverse member 14 or coupled base (12a or 12) in at least a second direction with respect to a given base 12a or 12 being coupled to. For example, coupler 15 substantially prevents movement of the middle portion of a coupled transverse member 14 or top portion of base 12a, 12 in at least a first direction, i.e., away from wedge shaped base 12a, while foot couplers 34 and 34′ substantially prevent movement of the bottom portion of transverse member 14, a second base 12, or a second base 12a in at least a second direction, i.e., towards a first base 12a to which such component is coupled by the foot coupler.

It will be apparent from the examples seen in FIGS. 17B-17C that one or more of the apertures 74 of any given coupler 34, 34′ are not necessarily used, such that some apertures may receive a foot (e.g., foot 30 of a transverse member, foot 20 of a rectangular base 12, or one of feet 20a-20d of a wedge shaped base 12a), while one or more other apertures 74 may remain empty, depending on the particular modular furniture assembly configuration desired. FIGS. 17B-17C label several of the particular feet received within apertures 74 so as to illustrate this feature.

As will be appreciated by one of ordinary skill in the art, the foot couplers of the present invention do not need to be restricted as to the number of apertures 74 formed therein, nor the specific shapes shown. For example, a foot coupler of the present invention can be sized and configured to include any appropriate number of apertures, and any appropriate shape so as to couple the feet of a base (12a or 12) to another base (12a or 12), or to a transverse member 14. In one embodiment, apertures 74 can comprise a tapered opening so as to enable a consumer to more easily insert a foot therein. Use of the L-shaped foot couplers 34′ as seen in FIG. 17B prevent the foot couplers from extending outwardly past the vertical rear edge of the transverse members 14 coupled as backrest members. In other words, while a square or rectangular foot coupler 34 as seen in FIG. 16 could be used to make this coupling, one corner of the coupler 34 would then extend out past the edge of the overall couch or other furniture assembly, which is aesthetically undesirable, and or which creates a tripping hazard. The L-shaped foot coupler 34′ thus includes the same size and spacing of apertures as foot coupler 34, but with one aperture removed. It will be apparent that a triangular shaped foot coupler (i.e., filling in the hypotenuse between the legs of coupler 34′) could be provided, providing similar benefits as L-shaped foot coupler 34′.

The modular furniture assemblies are assembled in a similar manner as described in U.S. Pat. No. 9,277,826, only that one or more wedge shaped bases are included within the assembly, increasing the variety of configurations that can be made. FIG. 17A shows how two wedge shaped bases 12a can be coupled to one another, with a rectangular base 12 coupled on either side thereof. As shown, four transverse members 14 can be coupled to the back of each of bases 12a, 12, while another two transverse members 14 can be coupled to the sides of rectangular bases 12, forming armrests therefor. It will be apparent that were a wedge shaped base 12a forms an end of the couch or other furniture assembly (e.g., see FIG. 14), a transverse member 14 can be coupled to form an armrest against the angled side (y) of such a wedge shaped base 12a.

FIGS. 18A-18B shows front perspective views of the furniture assembly 50 seen in FIGS. 17A-17B. In FIG. 18B, the assembly is designated 50′, as a plurality of cushions 18b (which could also be termed pillows) have been added, positioned against those transverse members 14 serving as backrests and armrests.

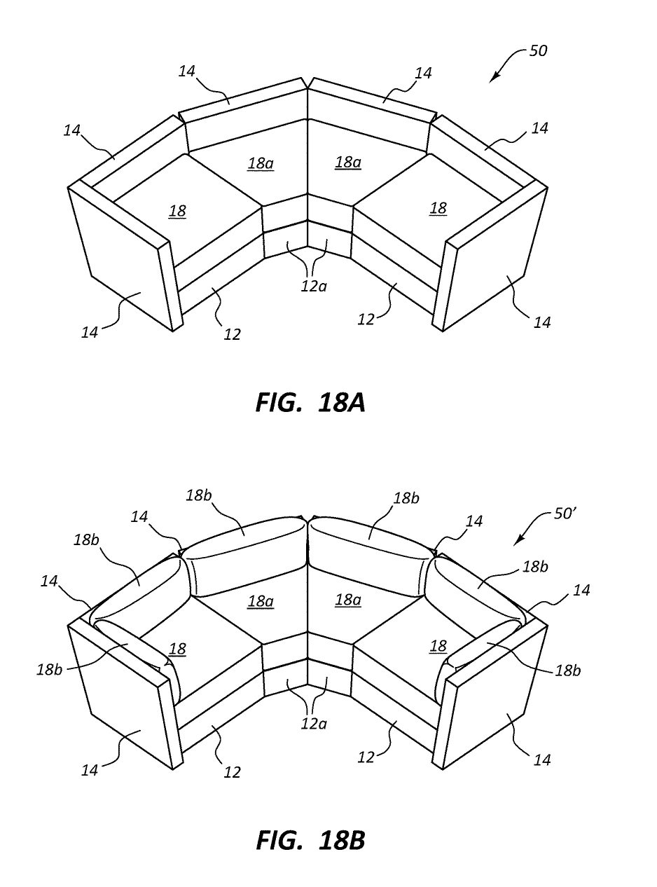

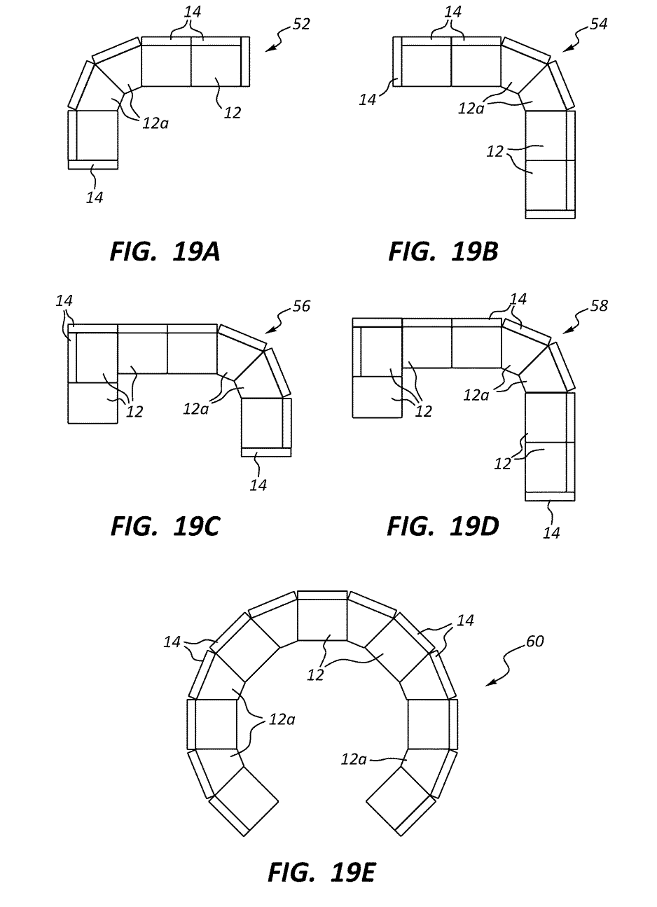

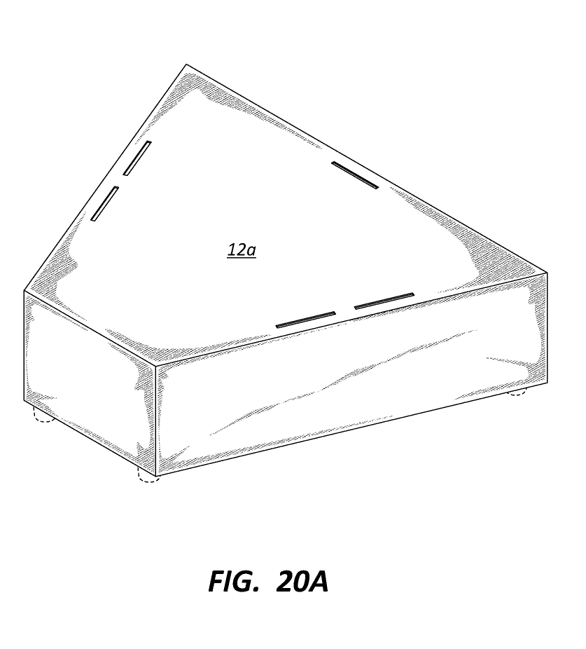

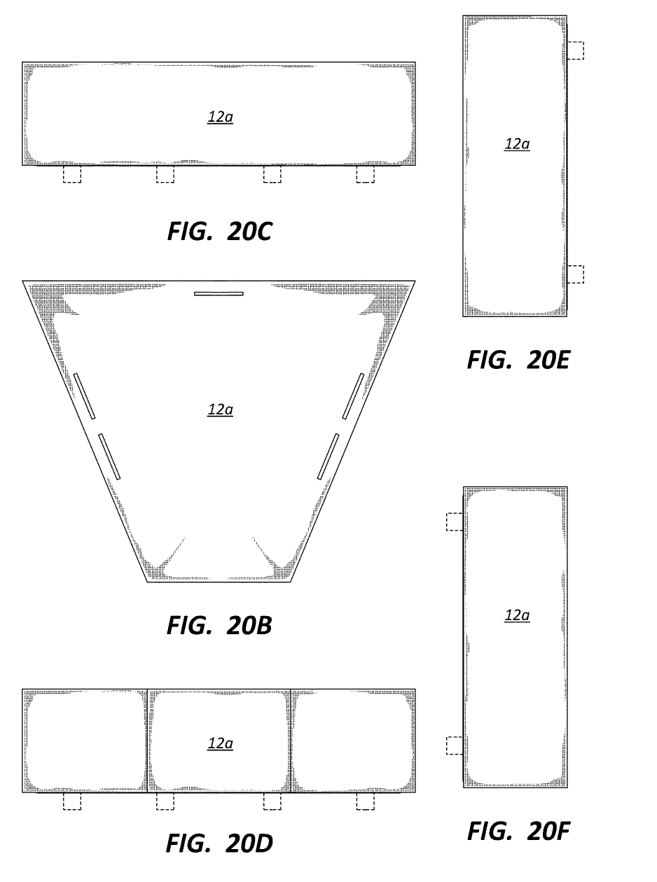

Because the furniture assemblies are modular, it will be apparent that numerous configurations other than those specifically illustrated can be formed, using any desired number of the three basic components (a wedge shaped base 12a, a rectangular base 12, and a transverse member 14). For example, FIG. 19A illustrates a configuration of a modular furniture assembly 52 that can be formed using two wedge shaped bases 12a, three rectangular bases 12, and seven transverse members 14. FIG. 19B shows another modular furniture assembly 54 that can be formed using two wedge shaped bases 12a, four rectangular bases 12, and eight transverse members. FIG. 19C shows another modular furniture assembly 56 that can be formed using two wedge shaped bases 12a, five rectangular bases 12, and eight transverse members. FIG. 19D shows another modular furniture assembly 58 that can be formed using two wedge shaped bases 12a, six rectangular bases 12, and nine transverse members. FIG. 19E shows another modular furniture assembly 60 that can be formed using six wedge shaped bases 12a, seven rectangular bases 12, and thirteen transverse members. It will be apparent that numerous other configurations are also possible, so that the potential configurations are nearly limitless.

Numbers, percentages, ratios, or other values stated herein may include that value, and also other values that are about or approximately the stated value, as would be appreciated by one of ordinary skill in the art. A stated value should therefore be interpreted broadly enough to encompass values that are at least close enough to the stated value to perform a desired function or achieve a desired result, and/or values that round to the stated value. The stated values include at least the variation to be expected in a typical manufacturing process, and may include values that are within 15%, within 10%, within 5%, within 1%, etc. of a stated value. Furthermore, the terms “substantially”, “similarly”, “about” or “approximately” as used herein represent an amount or state close to the stated amount or state that still performs a desired function or achieves a desired result. For example, the term “substantially” “about” or “approximately” may refer to an amount that is within 15%, within 10% of, within 5% of, or within 1% of, a stated amount or value.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A modular furniture assembly comprising:
a transverse member having a length (x′) and a width (z);
a wedge shaped base configured such that the wedge shaped base has a length (x) at a back thereof and an angled side length (y);
wherein the wedge shaped base and the transverse member have a defined spatial relationship, the defined spatial relationship being:
the length (x) of the back of the wedge shaped base is substantially equal to the length (x′) of the transverse member, and
the length (x) of the back of the wedge shaped base is substantially equal to the sum of the length of the angled side (y) of the wedge shaped base and the width (z) of the transverse member, such that different furniture configurations can be formed.

2. A modular furniture assembly as recited in claim 1, further comprising a rectangular base having a length (x) and a width (y).

3. A modular furniture assembly as recited in claim 1, wherein the wedge shaped base is configured such that two of the wedge shaped bases, being of identical design, would form a corner within the modular furniture assembly.

4. A modular furniture assembly as recited in claim 1, wherein the transverse member has a height that is greater than a height of the wedge shaped base.

5. A modular furniture assembly as recited in claim 1, wherein the wedge shaped base is generally triangular in shape, generally a truncated triangle in shape, or generally trapezoidal in shape.

6. A modular furniture assembly as recited in claim 1, wherein the angled side of the base is angled at 45°.

7. A modular furniture assembly as recited in claim 1, wherein the angled side of the base is angled at about 45°.

8. A modular furniture assembly as recited in claim 6, wherein the wedge shaped base has two angled sides, where both angled sides of the base are angled at about 45°.

9. A modular furniture assembly as recited in claim 1, wherein the wedge shaped base comprises a frame assembly and a cushion positionable over the frame assembly, wherein both the frame assembly and the cushion include the wedge shape of the wedge shaped base.

10. A modular furniture assembly as recited in claim 1, further comprising at least one foot coupler configured to facilitate detachable coupling of the transverse member to the wedge shaped base.

11. A modular furniture assembly as recited in claim 1, wherein the wedge shaped base is configured such that the wedge shaped base has a length (x) at a back thereof and angled side lengths (y) on each side thereof, and wherein an angle between one of the angled side lengths (y) and the other of the angled side lengths (y) is about 45°, and wherein the wedge shaped base has at least one aperture therein for selectively receiving a coupler for coupling the wedge shaped base to the transverse member.

12. (canceled)

13. A modular furniture assembly as recited in claim 1, wherein the modular furniture assembly comprises:
an upper coupling mechanism for coupling the transverse member to the wedge shaped base, the upper coupling mechanism selectively coupling a middle portion of the transverse member to a location of the wedge shape base that is at or near a top of the wedge shaped base;
a lower coupling mechanism for coupling the transverse member to the wedge shaped base, the lower coupling mechanism selectively coupling a bottom portion of the transverse member to a location of the wedge shape base that is at or near a bottom of the wedge shaped base.

14. A modular furniture assembly comprising:
first and second transverse members, each having a length (x′) and a width (z);
a wedge shaped base configured such that the wedge shaped base has a length (x) at a back thereof and an angled side length (y);
a rectangular base configured such that the rectangular base has a length (x) and a width (y);
wherein the wedge shaped base, the rectangular base, and the transverse members have a defined spatial relationship, the defined spatial relationship being:
the length (x) of the back of the wedge shaped base and the length (x) of the rectangular base are each substantially equal to the length (x′) of each of the transverse members, and
the length (x) of the back of the wedge shaped base and the length (x) of the rectangular base are each substantially equal to the sum of (y) and (z), wherein (y) is both the length of the angled side of the wedge shaped base and the width of the rectangular base, and (z) is the width of each of the transverse members, such that (x)=(y)+(z), and (x′)=(y)+(z), such that different furniture configurations can be formed;
wherein the first transverse member is selectively coupleable to the back of the wedge shaped base and the rectangular base is selectively coupleable to the angled side of the wedge shaped base, and the second transverse member is selectively coupleable to the rectangular base.

15. A modular furniture assembly as recited in claim 14, further comprising a third transverse member also having a length (x′) and a width (z).

16. A modular furniture assembly as recited in claim 14, wherein the angled side of the base is angled at 45°.

17. A modular furniture assembly as recited in claim 14, wherein the angled side of the base is angled at about 45°.

18. (canceled)

19. (canceled)

20. (canceled)

21. A modular furniture assembly as recited in claim 14, wherein the modular furniture assembly comprises:
an upper coupling mechanism for coupling either of the transverse members to the wedge shaped base, the upper coupling mechanism selectively coupling a middle portion of either transverse member to a location of the wedge shape base that is at or near a top of the wedge shaped base;
a lower coupling mechanism for coupling either of the transverse members to the wedge shaped base, the lower coupling mechanism selectively coupling a bottom portion of either transverse member to a location of the wedge shape base that is at or near a bottom of the wedge shaped base.

22. A modular furniture assembly as recited in claim 14, wherein each transverse member and the wedge shaped base each comprise a removable cover.

23. A modular furniture assembly as recited in claim 14, further comprising a second rectangular base having a length (x) and a width (y), the second rectangular base being selectively coupleable to the second angled side of the wedge shaped base.

24. A modular furniture assembly comprising:
a plurality of transverse members, each having a length (x′) and a width (z);
first and second wedge shaped bases, each wedge shaped base being configured such that the wedge shaped bases each have a length (x) at a back thereof and an angled side length (y);
a rectangular base configured such that the rectangular base has a length (x) and a width (y);
wherein the wedge shaped bases, the rectangular base, and the transverse members have a defined spatial relationship, the defined spatial relationship being:
the length (x) of the back of each wedge shaped base and the length (x) of the rectangular base are each substantially equal to the length (x′) of each of the transverse members, and
the length (x) of the back of each wedge shaped base and the length (x) of the rectangular base are each substantially equal to the sum of (y) and (z), wherein (y) is both the length of the angled side of each wedge shaped base and the width of the rectangular base, and (z) is the width of each of the transverse members, such that (x)=(y)+(z), and (x′)=(y)+(z), such that different furniture configurations can be formed;
wherein the first wedge shaped base is selectively coupleable to the second wedge shaped base along corresponding angled sides of the first and second wedge shaped bases so as to form a 90° bend across the first and second wedge shaped bases;
wherein the rectangular base is selectively coupleable to a remaining angled side of the wedge shaped base, and the plurality of transverse members are selectively coupleable to the wedge shaped bases and/or the rectangular base.

25. (canceled)

26. (canceled)

27. (canceled)

28. (canceled)

29. (canceled)

30. (canceled)
